(19) United States
(12) Patent Application Publication
(10) Pub. No.: US 2021/0199451 A1
(43) Pub. Date: Jul. 1, 2021

(54) MOVEMENT PLAN PRODUCING SYSTEM AND MOVEMENT PLAN PRODUCING METHOD FOR HYDROGEN FILLING VEHICLE

(71) Applicant: TOYOTA JIDOSHA KABUSHIKI KAISHA, Toyota-shi (JP)

(72) Inventors: Shigeaki MURATA, Nisshin-shi (JP); Takashi HARAYAMA, Toyota-shi (JP); Ayano ASAI, Anjo-shi (JP); Koji TERASHIMA, Nagoya-shi (JP); Takahiko HASEGAWA, Toyota-shi (JP); Tomio YAMANAKA, Nagoya-shi (JP); Koichi NUMATA, Mishima-shi (JP); Syun YOSHIDA, Nagoya-shi (JP)

(73) Assignee: TOYOTA JIDOSHA KABUSHIKI KAISHA, Toyota-shi (JP)

(21) Appl. No.: 17/125,157

(22) Filed: Dec. 17, 2020

(30) Foreign Application Priority Data
Dec. 27, 2019 (JP) 2019-237973

(51) Int. Cl. G01C 21/34; F17C 5/00; B60S 5/02

(52) U.S. Cl. CPC G01C 21/3438; F17C 5/007; B60S 5/02; F17C 2270/0168; B60K 2015/03315; F17C 2250/0408; F17C 2250/032; F17C 2250/0478; F17C 2221/012

(57) ABSTRACT

A movement plan producing system that produces a movement plan for a hydrogen filling vehicle includes: a residual hydrogen amount information acquisition portion that communicates with a plurality of vehicles using hydrogen gas as fuel to acquire residual hydrogen amount information indicating a residual hydrogen amount in a hydrogen tank of each of the vehicles; a positional information acquisition portion that acquires positional information indicating the position of each of the plurality of vehicles; and a plan producing portion that produces the movement plan for making the hydrogen filling vehicle fill at least some of the plurality of vehicles with hydrogen using the acquired residual hydrogen amount information and the acquired positional information.

### CROSS-REFERENCE TO RELATED APPLICATIONS

This application claims priority from Japanese application No. 2019-237973 filed on Dec. 27, 2019, the disclosure of which is hereby incorporated in its entirety by reference into this application.

### BACKGROUND

### Field

This disclosure relates to a movement plan producing system and a movement plan producing method for a hydrogen filling vehicle.

### Related Art

A configuration conventionally known uses a hydrogen filling vehicle as a mobile hydrogen station for filling a hydrogen tank provided at a fuel cell vehicle with hydrogen. Like a method disclosed in Japanese Patent Application Publication No. 2017-194745, for example, a method known as a method of producing a plan for arrangement of a hydrogen filling vehicle is such that a hydrogen demand expected amount in each area in which the hydrogen filling vehicle is movable is calculated on the basis of the actual number of received visitors, actual sales volume, etc., and a plan for arranging the hydrogen filling vehicle for causing the hydrogen filling vehicle to make a round of areas is produced using the calculated hydrogen demand expected amount.

However, divergence may be caused between a performance value in the past such as the number of visitors or sales volume and an actually demanded amount. The present inventors have found that such a problem occurs not only when the filling vehicle makes a round of areas but also when the filling vehicle makes a round of vehicles and fills these vehicles with hydrogen.

### SUMMARY

According to an aspect of this disclosure, a movement plan producing system that produces a movement plan for a hydrogen filling vehicle is provided. The movement plan producing system includes: a residual hydrogen amount information acquisition portion that communicates with a plurality of vehicles using hydrogen gas as fuel to acquire residual hydrogen amount information indicating a residual hydrogen amount in a hydrogen tank of each of the vehicles; a positional information acquisition portion that acquires positional information indicating the position of each of the plurality of vehicles; and a plan producing portion that produces the movement plan for making the hydrogen filling vehicle fill at least some of the plurality of vehicles with hydrogen using the acquired residual hydrogen amount information and the acquired positional information.

### BRIEF DESCRIPTION OF THE DRAWINGS

FIG. 1 is an explanatory view schematically showing the configuration of a hydrogen charging system;

FIG. 2 is an explanatory view showing functional blocks of the hydrogen charging system;

FIG. 3 is a flowchart showing a movement plan producing process;

FIG. 4 is an explanatory view showing functional blocks of a hydrogen charging system;

FIG. 5 is a flowchart showing a movement plan producing process; and

FIG. 6 is a flowchart showing a movement plan producing process.

### DETAILED DESCRIPTION

### A. First Embodiment

### [A-1] Overall System Configuration

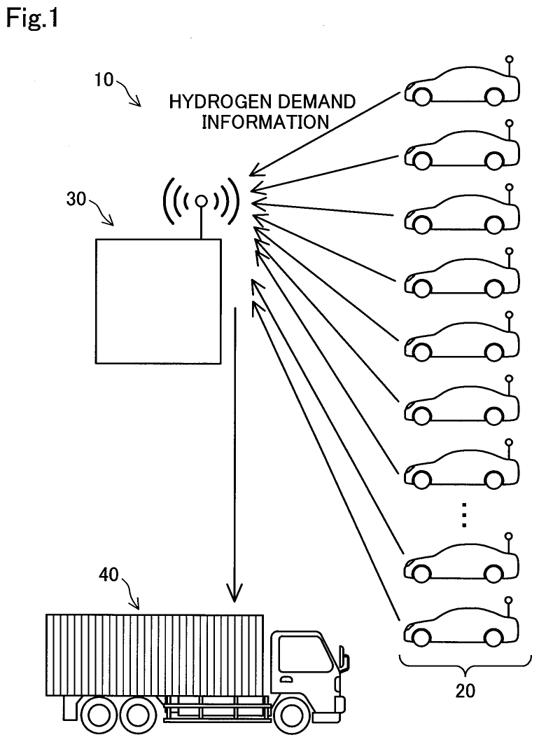

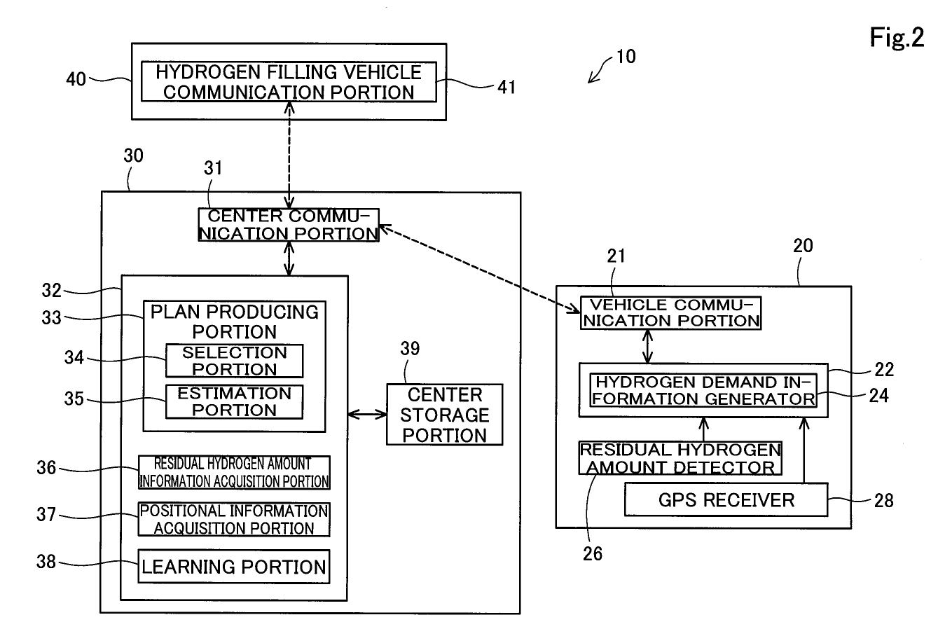

FIG. 1 is an explanatory view schematically showing the configuration of a hydrogen charging system 10 including a movement plan producing system 30 according to a first embodiment of this disclosure. FIG. 2 is an explanatory view showing functional blocks of the hydrogen charging system 10. The configuration of the hydrogen charging system 10 will be described below using FIGS. 1 and 2. The hydrogen charging system 10 of the first embodiment includes a plurality of vehicles 20, a hydrogen filling vehicle 40 for filling at least some of the plurality of vehicles 20 with hydrogen, and the movement plan producing system 30 that makes a movement plan for the hydrogen filling vehicle 40.

The vehicle 20 is a fuel cell vehicle with a fuel cell installed as one of driving energy sources. The vehicle 20 includes a hydrogen tank storing hydrogen to be supplied to the fuel cell. The vehicle 20 has a function of communicating with the movement plan producing system 30. The vehicle 20 is set in advance as a vehicle for which hydrogen filling by the hydrogen filling vehicle 40 is intended in a region in which the hydrogen filling vehicle 40 offers hydrogen filling service. The vehicle 20 may be a vehicle used by a contractor having made a contract with a corporation, for example, of doing business relating to hydrogen filling for receiving hydrogen filling service by the hydrogen filling vehicle 40. The vehicle 20 is a target of acquisition of hydrogen demand information described later to be acquired by the movement plan producing system 30 and may be a target of hydrogen filling by the hydrogen filling vehicle 40. In the first embodiment, all the vehicles 20 in the hydrogen charging system 10 have the same configuration as a configuration relating to the foregoing movement plan production. For the convenience of illustration, only one vehicle 20 is shown in FIG. 2.

As shown in FIG. 2, the vehicle 20 includes a vehicle communication portion 21, a residual hydrogen amount detector 26, a GPS receiver 28, and a vehicle data processor 22. In the following description, each vehicle 20 itself may also be called an “own vehicle.” The vehicle communication portion 21 is a portion for communicating with a center communication portion 31 of the movement plan producing system 30 described later. The residual hydrogen amount detector 26 detects a residual hydrogen amount in a hydrogen tank of the own vehicle. The residual hydrogen amount detector 26 may be a pressure sensor to detect a pressure in the hydrogen, for example. The GPS receiver 28 determines a current position (longitude and latitude) of the own vehicle on the basis of radio waves received from an artificial satellite forming a global positioning system (GPS). The GPS receiver 28 is not limited to a GPS but it may be configured using a portion to identify a current position of the own vehicle using signals from another optional global navigation satellite system (GNSS) such as Galileo or QZSS, for example.

The vehicle data processor 22 is configured using a computer including a CPU, a ROM, a RAM, and an input/output port. The vehicle data processor 22 includes a hydrogen demand information generator 24. The hydrogen demand information generator 24 is realized by causing the CPU of the vehicle data processor 22 to develop a control program in the ROM onto the RAM and to execute the developed control program. The hydrogen demand information generator 24 performs a process of generating hydrogen demand information that is information including residual hydrogen amount information indicating a residual hydrogen amount in a hydrogen tank of the own vehicle. More specifically, the hydrogen demand information generator 24 generates the residual hydrogen amount information using a detection result obtained by the residual hydrogen amount detector 26. The hydrogen demand information generator 24 further generates positional information indicating a current position of the own vehicle using a positioning result obtained by the GPS receiver 28. Then, the hydrogen demand information generator 24 generates the hydrogen demand information including the residual hydrogen amount information and the positional information.

The vehicle data processor 22 generates the foregoing hydrogen demand information at a time interval set in advance, and transmits the generated hydrogen demand information repeatedly to the movement plan producing system 30 via the vehicle communication portion 21. The vehicle data processor 22 generates and transmits the hydrogen demand information at a frequency that may be once a day, once every few days, or once a week, for example. This frequency may be higher than the frequency of once a day, or lower than the frequency of once a week. The foregoing time interval may be set appropriately in such a manner that a difference between a residual hydrogen amount in the hydrogen tank at the time of generation of the residual hydrogen amount information and a residual hydrogen amount in the hydrogen tank at the time of charging of the hydrogen tank of each vehicle 20 with hydrogen by the hydrogen filling vehicle 40 according to a produced movement plan falls within a permissible range.

Instead of the configuration of generating and transmitting the hydrogen demand information at the preset time interval, or in addition to the configuration of generating and transmitting the hydrogen demand information at the preset time interval, the foregoing hydrogen demand information may be transmitted at a timing set by a user of the vehicle 20. Instead of the configuration of generating and transmitting the hydrogen demand information at the preset time interval, or in addition to the configuration of generating and transmitting the hydrogen demand information at the preset time interval, the vehicle 20 may generate and transmit the hydrogen demand information at a timing requested by the movement plan producing system 30. Alternatively, the foregoing hydrogen demand information may be generated and transmitted when the vehicle 20 is brought to a particular state determined in advance such as a stopped state of a vehicle system responsive to turn-off of a start switch for the vehicle 20. If the hydrogen demand information is generated and transmitted when the vehicle system is stopped, information indicating a position where the vehicle 20 is parked during the stopped state of the vehicle system may be transmitted as the positional information.

The positional information included in the hydrogen demand information is used for identifying a location to which the hydrogen filling vehicle 40 is to go for charging the hydrogen tank of the vehicle 20 with hydrogen, as described later. For this reason, when the vehicle 20 is parked at a location to which the hydrogen filling vehicle 40 is desired to go for hydrogen charging, the vehicle 20 may transmit the hydrogen demand information including the positional information in response to an instruction from a user of the vehicle 20. Instead of the positional information acquired by the GPS receiver 28, a particular location such as a home address to which the hydrogen filling vehicle 40 is desired to go may be set and stored in advance, and the vehicle data processor 22 may transmit the hydrogen demand information including information indicating the preset location as the positional information. In another case, instead of the configuration of transmitting the residual hydrogen amount information and the positional information together as the hydrogen demand information, the residual hydrogen amount information and the positional information may be transmitted separately. If the residual hydrogen amount information and the positional information are to be transmitted separately, each of the residual hydrogen amount information and the positional information may be given vehicle identification information, for example, to allow the movement plan producing system 30 to associate the received residual hydrogen amount information and positional information with each other.

The movement plan producing system 30 has a function of communicating with the vehicle 20. The movement plan producing system 30 receives hydrogen demand information transmitted from each vehicle 20, and produces a movement plan for the hydrogen filling vehicle 40. In a configuration of receiving hydrogen demand information pieces simultaneously from all the vehicles 20, for example, the movement plan may be produced at a timing of the receipt. In a configuration of receiving hydrogen demand information pieces from all the vehicles 20 according to different timings, for example, the movement plan may be produced at a timing determined in advance independently of the timings of receipts of the hydrogen demand information pieces. In this case, the foregoing movement plan may be produced using the latest one of the hydrogen demand information pieces received from all the vehicles 20.

As shown in FIG. 2, the movement plan producing system 30 includes the center communication portion 31, a center processor 32, and a center storage portion 39. In the first embodiment, the movement plan producing system 30 is configured using a server installed at a location of business of a corporation, for example, of doing business relating to hydrogen filling using the hydrogen filling vehicle 40. Alternatively, the movement plan producing system 30 may be configured using a virtual server provided on the cloud. Like in this case, the movement plan producing system 30 may be installed at any location.

The center communication portion 31 is a portion for communicating with the vehicle communication portion 21 of each vehicle 20 and with a hydrogen filling vehicle communication portion 41 of the hydrogen filling vehicle 40 described later. The center communication portion 31 receives the hydrogen demand information about the vehicle 20 from the vehicle communication portion 21, and transmits information (also called “movement plan information”) indicating a movement plan for the hydrogen filling vehicle 40 produced using the received hydrogen demand information to the hydrogen filling vehicle communication portion 41.

The center processor 32 is configured using a computer including a CPU, a ROM, a RAM, and an input/output port. The CPU of the center processor 32 performs an operation of producing a movement plan for the hydrogen filling vehicle 40 using the residual hydrogen amount information and the positional information described above about the vehicle 20 to function as a plan producing portion 33, a residual hydrogen amount information acquisition portion 36, a positional information acquisition portion 37, and a learning portion 38.

The plan producing portion 33 includes a selection portion 34 and an estimation portion 35. For implementation of the foregoing plan producing operation, the selection portion 34 selects a vehicle to become a target of charging with hydrogen gas (hereinafter also called a “charging target vehicle”) from all the vehicles 20 having transmitted hydrogen demand information pieces. For implementation of the foregoing plan producing operation, the estimation portion 35 estimates a residual hydrogen amount in the hydrogen tank of the vehicle 20 at the time of hydrogen charging by the hydrogen filling vehicle 40 using the residual hydrogen amount information received from the vehicle 20. The plan producing portion 33 produces a movement plan for the hydrogen filling vehicle 40 using the residual hydrogen amount estimated for the foregoing charging target vehicle. The movement plan may include at least a movement route for the hydrogen filling vehicle 40 for charging the charging target vehicle with hydrogen. The movement plan may further include scheduled date and time of charging when the hydrogen filling vehicle 40 is to reach each charging target vehicle for hydrogen charging, or a scheduled amount of charging by which each charging target vehicle is to be charged with hydrogen.

The residual hydrogen amount information acquisition portion 36 acquires the residual hydrogen amount information from the hydrogen demand information received from the vehicle 20. The positional information acquisition portion 37 acquires the positional information from the hydrogen demand information received from the vehicle 20. These residual hydrogen amount information and positional information are used by the plan producing portion 33 for production of the movement plan described above.

The learning portion 38 learns a state of change in a residual hydrogen amount at each vehicle 20 using the residual hydrogen amount information transmitted repeatedly from each vehicle 20. More specifically, using the residual hydrogen amount information transmitted repeatedly from each vehicle 20, the learning portion 38 learns a time zone, a day, timing, season, etc. when a residual hydrogen amount is likely to be reduced, or a chronological pattern of reduction of a residual hydrogen amount about each vehicle 20, for example, and stores the learned information into the center storage portion 39 described later.

The hydrogen filling vehicle 40 makes a round of charging target vehicles according to the movement plan produced by the movement plan producing system 30, and charges hydrogen tanks of the charging target vehicles with hydrogen. The hydrogen filling vehicle 40 may be a vehicle equipped with a hydrogen reservoir storing high-pressure hydrogen gas. In response to a capacity of storing hydrogen in the hydrogen reservoir provided to the hydrogen filling vehicle 40, the number of vehicles 20 is determined that are to become targets of charging by the hydrogen filling vehicle 40 while the hydrogen filling vehicle 40 makes one round.

The hydrogen filling vehicle 40 includes the hydrogen filling vehicle communication portion 41. The hydrogen filling vehicle communication portion 41 is a portion for communicating with the center communication portion 31 of the movement plan producing system 30. The hydrogen filling vehicle 40 receives the movement plan information from the movement plan producing system 30 via the hydrogen filling vehicle communication portion 41 indicating the movement plan for the hydrogen filling vehicle 40 produced by the movement plan producing system 30. As described above, the movement plan information received by the hydrogen filling vehicle communication portion 41 may include a movement route for the hydrogen filling vehicle 40, scheduled date and time of charging when the hydrogen filling vehicle 40 is to reach each charging target vehicle, etc. Such movement plan information is input to a navigation portion installed on the hydrogen filling vehicle 40, for example. This allows the hydrogen filling vehicle 40 to make a round easily according to the produced movement plan.

In addition to being input to the navigation portion of the hydrogen filling vehicle 40, the movement plan information received by the hydrogen filling vehicle 40 may be output in a manner allowing visual recognition by an operator of the hydrogen filling vehicle 40 by being displayed on a particular position of the hydrogen filling vehicle 40, for example. Alternatively, instead of the configuration of transmitting the movement plan information produced by the movement plan producing system 30 to the hydrogen filling vehicle communication portion 41 of the hydrogen filling vehicle 40 or in addition to the configuration of transmitting this movement plan information to the hydrogen filling vehicle communication portion 41, the movement plan information may be transmitted to a portable terminal owned by the operator of the hydrogen filling vehicle 40.

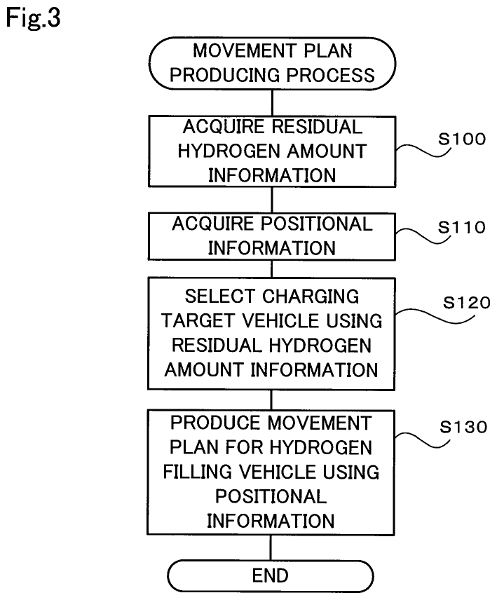

FIG. 3 is a flowchart showing a routine of a movement plan producing process executed by the CPU of the center processor 32. The movement plan producing process means a process of producing a movement plan for the hydrogen filling vehicle 40. In the movement plan producing system 30, this routine of the movement plan producing process is started and executed at a timing set in advance before the hydrogen filling vehicle 40 makes a round for hydrogen charging. Alternatively, this routine of the movement plan producing process may be executed repeatedly at a cycle set in advance.

When this routine is started, the residual hydrogen amount information acquisition portion 36 acquires residual hydrogen amount information about each vehicle 20 (step S100). As already described, the residual hydrogen amount information is included in hydrogen demand information received by the center communication portion 31 from each vehicle 20.

The positional information acquisition portion 37 acquires positional information about each vehicle 20 (step S110). As already described, the positional information is included in the hydrogen demand information received by the center communication portion 31 from each vehicle 20. One of step S100 and step S110 described above may be performed before the other, or these steps may be performed simultaneously.

Then, the selection portion 34 selects a charging target vehicle using the residual hydrogen amount information acquired in step S100 (step S120). As already described, the number of vehicles 20 to become targets of charging by the hydrogen filling vehicle 40 while the hydrogen filling vehicle 40 makes one round is determined in response to a capacity of storing hydrogen in the hydrogen reservoir provided to the hydrogen filling vehicle 40, the number of hydrogen tanks provided to the vehicles 20, and the sizes of these tanks. Alternatively, an upper limit of the number of vehicles 20 to become the foregoing targets of charging may be determined in response to a traveling distance coverable by the hydrogen filling vehicle 40 while the hydrogen filling vehicle 40 makes one round. The center processor 32 may set the number of vehicles 20 appropriately to become targets of charging by the hydrogen filling vehicle 40 while the hydrogen filling vehicle 40 makes one round, and select vehicles 20 of a number equal to or less than the set number as charging target vehicles from vehicles 20 having transmitted hydrogen demand information pieces, for example.

The charging target vehicle may be selected using at least the residual hydrogen amount information. More specifically, using the residual hydrogen amount information, a vehicle determined to have a smaller residual hydrogen amount in the hydrogen tank may be selected preferentially as a charging target vehicle over a vehicle determined to have a larger residual hydrogen amount, for example. Regarding a determination as to whether a residual hydrogen amount in the hydrogen tank is large or small, a residual hydrogen amount at each vehicle 20 at the time of hydrogen charging by the hydrogen filling vehicle 40 is estimated using the residual hydrogen amount information, and the foregoing determination may be made using the estimated value, for example. As described above, a residual hydrogen amount at each vehicle 20 at the time of hydrogen charging by the hydrogen filling vehicle 40 may be estimated using a state of change in a residual hydrogen amount at each vehicle 20 learned and stored into the center storage portion 39 by the learning portion 38. For example, if a movement plan for Saturday afternoon is to be produced on Friday, a charging target vehicle may be selected using a value obtained by subtracting a hydrogen amount learned and stored as an average hydrogen amount consumed on Saturday morning about each vehicle 20 from a residual hydrogen amount indicated by the residual hydrogen amount information. In another case, a residual hydrogen amount at each vehicle 20 at the time of actual hydrogen charging by the hydrogen filling vehicle 40 may be estimated in various ways in response to learned and stored information about a state of change in a residual hydrogen amount at each vehicle 20.

In another case, it may be determined whether a residual hydrogen amount in the hydrogen tank is large or small using a residual hydrogen amount as it is indicated by the residual hydrogen amount information without providing the estimation portion 35 and the learning portion 38 in the center processor 32 to select a charging target vehicle. In either case, by determining whether a residual hydrogen amount in the hydrogen tank is large or small and by selecting a vehicle determined to have a smaller residual hydrogen amount more preferentially as a charging target vehicle, it becomes possible to reduce the occurrence of excessive reduction of a residual hydrogen amount at each vehicle 20.

A charging target vehicle may be selected using not only a residual hydrogen amount or an estimated value of a residual hydrogen amount (hereinafter also called a “value such as residual hydrogen amount”) obtained from residual hydrogen amount information but also using positional information (in ascending order or descending order of distance from a standby position of the hydrogen filling vehicle 40), information about the presence or absence of a reservation for hydrogen charging, or details of a contract made by a user of each vehicle 20 (whether the contract is made to set a relatively high fee to become a charging target vehicle more preferentially). In the presence of a reservation for hydrogen charging for a vehicle, for example, this vehicle may be selected as a charging target vehicle preferentially.

In using a plurality of criteria including a value such as residual hydrogen amount, the position of the vehicle 20, and the presence or absence of a reservation, order of preference may be set between the criteria to be used for selecting a charging target vehicle. If a value such as residual hydrogen amount is used as a selection criterion given preference over positional information, for example, a vehicle 20 having a value such as residual hydrogen amount equal to or less than a predetermined reference value is selected as a charging target vehicle. If the number of vehicles 20 each having a value such as residual hydrogen amount equal to or less than the reference value falls short of the number of vehicles 20 capable of being charged with hydrogen during making of one round, charging target vehicles of a number corresponding to the shortage may be selected from vehicles 20 left out of selection in ascending order of distance of the positions of vehicles 20 indicated by positional information from a standby position of the hydrogen filling vehicle 40. However, this is not the only case. Order of preference to be applied as a criterion for selecting a charging target vehicle is freely settable. Alternatively, each of the plurality of criteria including a value such as residual hydrogen amount, the position of the vehicle 20, and the presence or absence of a reservation may be given a point. For example, a higher point may be given as a value such as residual hydrogen amount is smaller, a higher point may be given as the position of the vehicle 20 is closer to a standby position of the hydrogen filling vehicle 40, a lower point may be given in the presence of a stationary-type hydrogen station near the position of the vehicle 20, or a higher point may be given to the presence of a reservation. By giving a point to each criterion in such a way, vehicles 20 may be selected as charging target vehicles in descending order of total of points given to the respective criteria.

After implementation of step S120, using the positional information acquired in step S110, the plan producing portion 33 produces a movement plan for the hydrogen filling vehicle 40 for causing the hydrogen filling vehicle 40 to make a round of charging target vehicles to fill the charging target vehicles with hydrogen (step S130). In producing the movement plan, a movement route for the hydrogen filling vehicle 40 may be set in such a manner as to cause the hydrogen filling vehicle 40 to make a round of all the charging target vehicles in ascending order or descending order of distance from a standby position of the hydrogen filling vehicle 40, for example. The movement route for the hydrogen filling vehicle 40 may also be set in such a manner as to reduce a total movement distance of the hydrogen filling vehicle 40 as much as possible, preferably, to a shortest distance. The movement route for the hydrogen filling vehicle 40 may also be set using current traffic holdup information or traffic holdup information in the past in such a manner as to avoid a congested road. In another case, the movement route for the hydrogen filling vehicle 40 may be set in such a manner as to make a round of all the charging target vehicles in ascending order of value such as residual hydrogen amount. After implementation of step S130 is finished, the movement plan producing process is finished.

After the movement plan for the hydrogen filling vehicle 40 is produced in step S130, the movement plan producing system 30 may transmit and notify movement plan information indicating the produced movement plan to each charging target vehicle or to a portable terminal of a user of each charging target vehicle, for example. This encourages the user of each charging target vehicle to wait in the vehicle before the hydrogen filling vehicle 40 arrives at the charging target vehicle. If a reply indicating the unnecessity of charging is given from the charging target vehicle after the movement plan information is notified as described above, the vehicle 20 having given the foregoing reply may be excluded from charging target vehicles before the hydrogen filling vehicle 40 starts making a round.

The movement plan producing system 30 of the first embodiment having the foregoing configuration communicates with the plurality of vehicles 20 to acquire residual hydrogen amount information, and produces a movement plan using the residual hydrogen amount information and positional information. This achieves an increased degree of accuracy of expectation of hydrogen demand for producing the foregoing movement plan, compared to a configuration of producing a movement plan on the basis of a performance value in the past. Namely, unlike a performance value in the past such as the number of visitors or sales volume, a residual hydrogen amount indicated by the residual hydrogen amount information, which shows a residual hydrogen amount actually measured by each vehicle 20, is usable in suppressing divergence from an actually demanded amount and producing a movement plan fulfilling actual demand. In particular, while the number of visitors, sales volume, etc. are assumable as a performance value in the past relating to hydrogen demand showing a tendency in each area, it is difficult by using these values to determine demand by each vehicle 20 properly. According to the first embodiment, demand by each vehicle 20 is determined properly to allow production of a movement plan appropriately for making a round of selected charging target vehicles. Additionally, according to the first embodiment, as the foregoing movement plan is produced using positional information about each vehicle 20, the position of the vehicle 20 to be charged with hydrogen, namely, a position which the hydrogen filling vehicle 40 is to pass through during making a round is determined properly for producing a movement plan for the hydrogen filling vehicle 40.

According to the first embodiment, in making a movement plan for the hydrogen filling vehicle 40, a residual hydrogen amount at each vehicle 20 at the time of hydrogen charging is estimated using a state of change in a residual hydrogen amount at each vehicle 20 learned and stored into the center storage portion 39 by the learning portion 38. This achieves an increased degree of accuracy of determining a demanded amount of hydrogen at each vehicle 20 for producing the foregoing movement plan.

### B. Second Embodiment

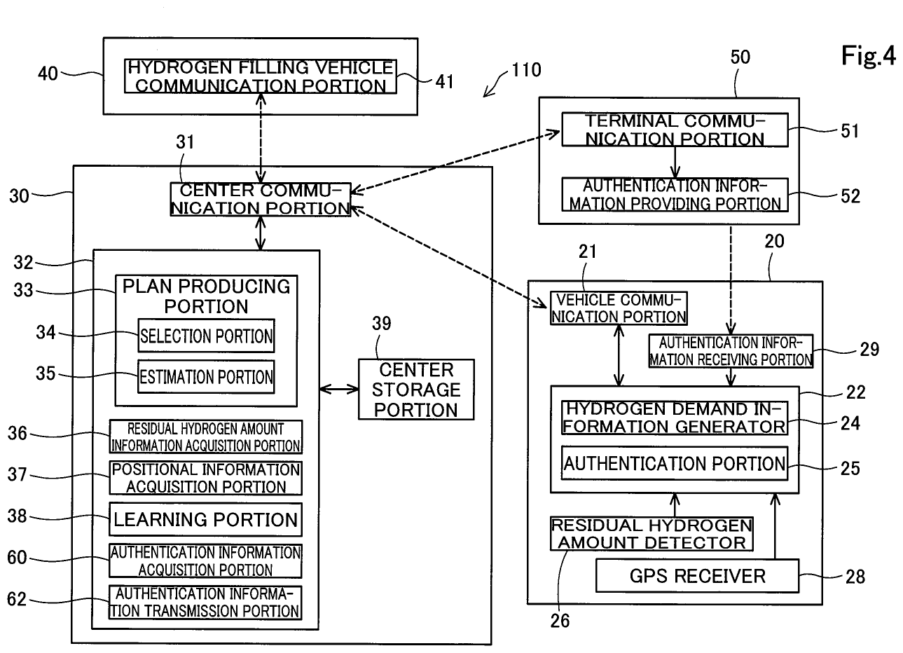

FIG. 4 is an explanatory view showing functional blocks of a hydrogen charging system 110 according to a second embodiment. In the second embodiment, a part common to that of the first embodiment will be given the same reference number and will not be described in detail. The hydrogen charging system 110 of the second embodiment performs an authentication process when a charging port lid covering a charging port formed at a vehicle body surface is to be unlocked for connecting the hydrogen tank of the vehicle 20 and the hydrogen filling vehicle 40. The following description is intended for differences of the hydrogen charging system 110 from the hydrogen charging system 10 of the first embodiment.

In the second embodiment, the center processor 32 of the movement plan producing system 30 further includes an authentication information acquisition portion 60 and an authentication information transmission portion 62. The authentication information acquisition portion 60 acquires authentication information about a selected charging target vehicle when the selection portion 34 selects this charging target vehicle. The authentication information is information used in the authentication process for unlocking the charging port lid of each vehicle 20. In the second embodiment, the authentication information about each vehicle 20 is stored together with its vehicle identification information in the center storage portion 39. The authentication information acquisition portion 60 acquires authentication information about each selected charging target vehicle by reading this information from the center storage portion 39.

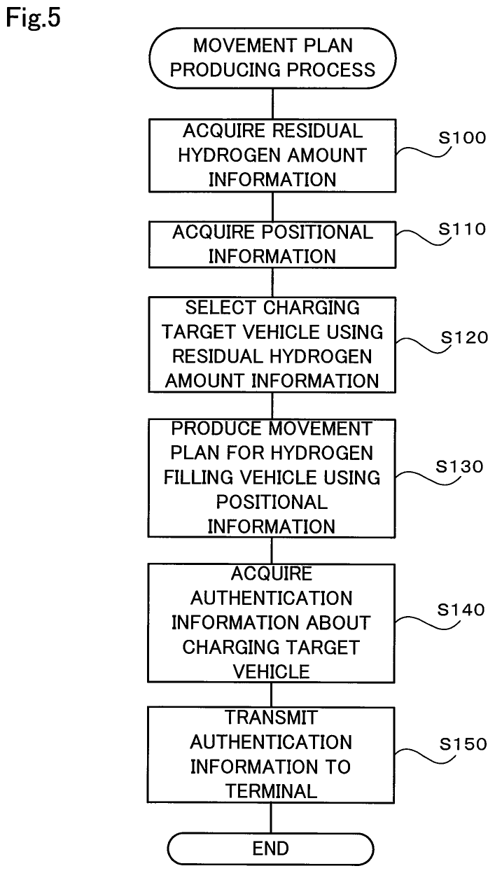

FIG. 5 is a flowchart showing a routine of a movement plan producing process executed by the CPU of the center processor 32 of the second embodiment. In FIG. 5, steps common to those in FIG. 3 are given the same reference numbers. The following description is intended for differences from the first embodiment.

After completion of step S130, namely, when production of the movement plan for the hydrogen filling vehicle 40 is finished, the authentication information acquisition portion 60 acquires authentication information about a selected charging target vehicle (step S140). The authentication information may be acquired about all selected charging target vehicles, for example. Then, the authentication information transmission portion 62 transmits the authentication information acquired in step S140 to a portable terminal 50 described later via the center communication portion 31 (step S150). Instead of being performed after step S130, step S140 and step S150 may be performed before implementation of step S130 and after selection of the charging target vehicle by the selection portion 34 in step S120.

Referring back to FIG. 4, the hydrogen charging system 110 further includes the portable terminal 50 owned by an operator of the hydrogen filling vehicle 40. The portable terminal 50 includes a terminal communication portion 51 and an authentication information providing portion 52. The terminal communication portion 51 is a portion for communicating with the center communication portion 31 of the movement plan producing system 30. The terminal communication portion 51 receives the authentication information about each charging target vehicle transmitted in step S150. The authentication information providing portion 52 makes near-field radio communication with the vehicle 20 to transmit the authentication information received by the terminal communication portion 51 to the charging target vehicle.

The vehicle 20 of the second embodiment further includes an authentication information receiving portion 29. The authentication information receiving portion 29 makes near-field radio communication with the portable terminal 50 to receive the authentication information transmitted from the authentication information providing portion 52 of the portable terminal 50. The vehicle data processor 22 further includes an authentication portion 25. The authentication portion 25 includes authentication information stored in advance. The authentication portion 25 performs the authentication process by checking the authentication information stored in the authentication portion 25 and the authentication information received by the authentication information receiving portion 29 against each other. If the authentication process by the authentication portion 25 is performed successfully, the authentication portion 25 outputs an unlock signal. This drives an actuator not shown in the drawings and provided to the vehicle 20 to unlock the charging port lid of the vehicle 20.

According to the second embodiment, the portable terminal 50 functions as an electronic key. Alternatively, a configuration comparable to the terminal communication portion 51 and the authentication information providing portion 52 relating to the authentication process may be provided at the hydrogen filling vehicle 40 to make the hydrogen filling vehicle 40 function as an electronic key. In this configuration, the authentication information is transmitted to the hydrogen filling vehicle 40 in step S150.

The configuration described above is such that, if the authentication process using the portable terminal 50 is performed successfully, the charging port lid of the vehicle 20 is unlocked. However, a different configuration is applicable, as long as the charging port lid is ready to be unlocked. For example, with a door of the vehicle 20 being ready to be unlocked using the foregoing function as an electronic key, the charging port lid may be unlocked by unlocking the door of the vehicle 20 and then by causing an operator of the hydrogen filling vehicle 40 to operate a switch provided inside a vehicle for unlocking the charging port lid. In another case, the foregoing function as an electronic key may be used for making both the door and the charging port lid of the vehicle 20 ready to be unlocked. However, making only the charging port lid ready to be unlocked is more desirable in terms of ensuring security.

The second embodiment described above eliminates a need for a user of a charging target vehicle to wait in the vehicle for hydrogen charging by the hydrogen filling vehicle 40, thereby improving convenience. Namely, according to the second embodiment, even in the absence of a user of a charging target vehicle, hydrogen charging is still realized by causing an operator of the hydrogen filling vehicle 40 to unlock the charging port lid of the charging target vehicle. According to the second embodiment, authentication information about a selected charging target vehicle is acquired, if necessary, to improve security.

### C. Third Embodiment

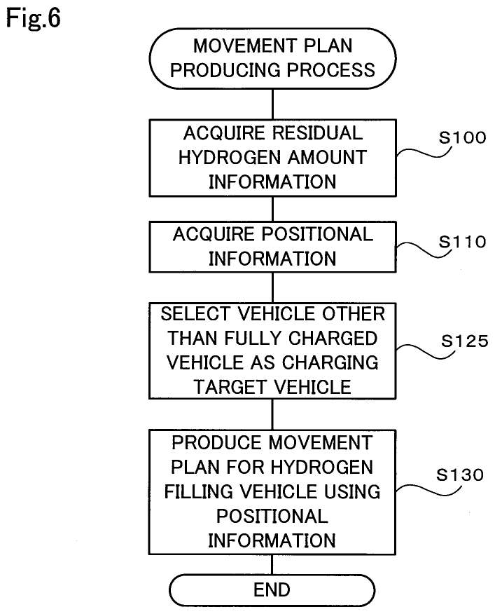

FIG. 6 is a flowchart showing a routine of a movement plan producing process executed by the CPU of the center processor 32 of a third embodiment. The movement plan producing process of the third embodiment differs from that of the first embodiment in a criterion for selecting a charging target vehicle. More specifically, the movement plan producing process of the third embodiment differs from the movement plan producing process of the first embodiment shown in FIG. 3 in that step S125 is performed instead of step S120. Other procedures of the movement plan producing process and other device structures of the third embodiment are the same as those of the first embodiment. Thus, a common step and a common constituting element are identified by the same signs and will not be described in detail. The following description is intended for differences of the movement plan producing process of the third embodiment from the movement plan producing process of the first embodiment.

After implementation of step S110, the selection portion 34 selects a vehicle 20 having a hydrogen tank determined not to be fully charged as a charging target vehicle (step S125) using the residual hydrogen amount information acquired in step S100. Regarding a vehicle 20 at which a residual hydrogen amount is estimated from a result of learning by the learning portion 38 not to be an amount corresponding to full charging at the time of hydrogen charging by the hydrogen filling vehicle 40, even if residual hydrogen amount information acquired about this vehicle 20 indicates full charging, this vehicle 20 may be selected as a charging target vehicle.

This configuration allows a vehicle having a hydrogen tank not in a fully charged state to be selected as a charging target vehicle. This makes it possible to perform hydrogen charging using the hydrogen filling vehicle 40 before a residual hydrogen amount in the hydrogen tank of each vehicle 20 becomes an excessively reduced state. Namely, if each vehicle 20 consumes hydrogen, this vehicle 20 is charged readily with hydrogen to reduce the occurrence possibility of hydrogen shortage at the time of traveling of the vehicle 20.

The foregoing configuration of performing step S125 instead of step S120 may be applied to the hydrogen charging system 110 of the second embodiment. A resultant configuration allows implementation of hydrogen charging using the hydrogen filling vehicle 40 before a residual hydrogen amount in a hydrogen tank becomes an excessively reduced state while eliminating a need for a user of a charging target vehicle to wait in the vehicle. p In making a contract for receiving service of hydrogen charging using the hydrogen filling vehicle 40 with a corporation, for example, of doing business relating to hydrogen filling, a user of the vehicle 20 according to each of the first embodiment to the third embodiment may make the contract to pay a fee responsive to a charged hydrogen amount, for example. Alternatively, like the third embodiment of selecting a vehicle of a residual hydrogen amount being less than an amount of a fully charged amount as a charging target vehicle, for example, service of charging hydrogen in such a manner as to maintain a certain residual hydrogen amount may be offered under a contract defining payment of a flat fee in a fixed period of time. In another case, a general contract may be set under which service is offered to select a vehicle as a charging target vehicle if a residual hydrogen amount becomes equal to or less than a predetermined reference amount less than an amount of a fully charged state, and a special contract may be set under which service is offered by the payment of a higher fee than that under the general contract to select a vehicle as a charging target vehicle if a residual hydrogen amount becomes less than the amount of a fully charged state, like in the third embodiment.

Regarding a contract to offer service of charging hydrogen in such a manner as to maintain a certain residual hydrogen amount like the third embodiment of selecting a vehicle as a charging target vehicle if a residual hydrogen amount is less than an amount of a fully charged state, the contract may be set to give an advantage on condition that the vehicle 20 is to be provided as a power generator in disaster situations, for example. This advantage may be a reduced fee of hydrogen charging or reduced insurance on the vehicle 20, for example.

### D. Other Embodiments

(D1) While the plan producing portion 33 is provided in the movement plan producing system 30 in each of the foregoing embodiments, it may alternatively be provided in the hydrogen filling vehicle 40. For example, the hydrogen filling vehicle 40 may receive hydrogen demand information including residual hydrogen amount information from each contracted vehicle 20 in a zone in charge, and produce a movement plan for the hydrogen filling vehicle 40 itself.

(D2) In each of the foregoing embodiments, hydrogen demand information transmitted from the vehicle 20 includes residual hydrogen amount information and positional information. However, a different configuration is applicable. As long as the hydrogen demand information includes at least the residual hydrogen amount information, the positional information may be omitted. In this case, positional information indicating a location about each vehicle 20 registered in advance as a location for hydrogen charging may be stored in advance in the center storage portion 39, and the positional information acquisition portion 37 may read and acquire the positional information about each vehicle 20 from the center storage portion 39 in step S110, for example. In another case, positional information registered in advance as information indicating a location for filling each vehicle 20 with hydrogen may be stored in a portion external to the movement plan producing system 30 instead of being stored in the movement plan producing system 30. In this case, the positional information acquisition portion 37 may communicate with this external device via the center communication portion 31 in step S110 to acquire the positional information about each vehicle 20. If the residual hydrogen amount information and the positional information are to be acquired separately like in the foregoing cases, each of the residual hydrogen amount information and the positional information may be given vehicle identification information, for example, to allow the movement plan producing system 30 to associate the acquired residual hydrogen amount information and positional information with each other.

(D3) In each of the foregoing embodiments, the hydrogen filling vehicle 40 makes a round of parking places of respective charging target vehicles. However, a different configuration is applicable. If a parking place of a charging target vehicle is not suitable as a parking place of the hydrogen filling vehicle 40 for reason of shortage of extra space, for example, the charging target vehicle may be moved to a place available for use for parking the hydrogen filling vehicle 40. In this case, the plan producing portion 33 of the movement plan producing system 30 may produce a movement plan for the hydrogen filling vehicle 40 using a place available for use for parking near the place of the movement instead of using a place indicated by positional information acquired by the positional information acquisition portion 37. In this case, parking place information indicating the foregoing place available for use for parking may be transmitted to the charging target vehicle. After receiving the parking place information, the charging target vehicle may input the received parking place information to a navigation portion. If the charging target vehicle is a vehicle capable of being driven autonomously, the received parking place information may alternatively be input to an autonomous driving portion.

(D4) In each of the foregoing embodiments, the movement plan producing system 30 selects a charging target vehicle from the plurality of vehicles 20 using the selection portion 34. However, a different configuration is applicable. For example, the movement plan producing system 30 may produce a movement plan on condition that the hydrogen filling vehicle 40 make a round of all the vehicles 20 defined in advance as vehicles to be charged with hydrogen by this hydrogen filling vehicle 40. Even in this case, producing a movement plan using residual hydrogen amount information and positional information about each vehicle 20 also achieves effects comparable to those achieved by the embodiments.

(D5) In the second embodiment, authentication information is transmitted from the movement plan producing system 30 to a charging target vehicle and the vehicle data processor 22 performs the authentication process, thereby unlocking a charging port lid of the charging target vehicle. However, a different configuration is applicable. For example, an operator of the hydrogen filling vehicle 40 may receive a key (physical key, for example) in advance for unlocking a charging port lid of each vehicle 20 having made a contract for hydrogen charging.

(D6) In a specific region, hydrogen charging of the plurality of vehicles 20 may be handled separately by the plurality of hydrogen filling vehicles 40. In this case, a movement plan may be produced for each hydrogen filling vehicle 40 while an area or a vehicle in the specific region to be handled by each hydrogen filling vehicle 40 is fixed. In another case, a movement plan may be produced for each hydrogen filling vehicle 40 while an area or a vehicle to be handled by each hydrogen filling vehicle 40 is changed in response to change in residual hydrogen amount information or positional information about each vehicle 20.

(D7) In each of the foregoing embodiments, the plurality of vehicles 20 as targets of hydrogen charging is a fuel cell vehicle. However, a different configuration is applicable. For example, at least some of the plurality of vehicles 20 may be vehicles each equipped with a hydrogen engine and a hydrogen tank for supplying hydrogen to the hydrogen engine, and each communicable with the movement plan producing system 30.

This disclosure is not limited to the above-described embodiments but is feasible in the form of various configurations within a range not deviating from the substance of the disclosure. For example, technical features in the embodiments corresponding to those in each of the aspects described in SUMMARY can be replaced or combined, where appropriate, with the intention of solving some or all of the aforementioned problems or achieving some or all of the aforementioned effects. Unless being described as absolute necessities in this specification, these technical features can be deleted, where appropriate. For example, this disclosure may be realized in the following aspects.

[1] According to one aspect of this disclosure, a movement plan producing system that produces a movement plan for a hydrogen filling vehicle is provided. The movement plan producing system includes: a residual hydrogen amount information acquisition portion that communicates with a plurality of vehicles using hydrogen gas as fuel to acquire residual hydrogen amount information indicating a residual hydrogen amount in a hydrogen tank of each of the vehicles; a positional information acquisition portion that acquires positional information indicating the position of each of the plurality of vehicles; and a plan producing portion that produces the movement plan for making the hydrogen filling vehicle fill at least some of the plurality of vehicles with hydrogen using the acquired residual hydrogen amount information and the acquired positional information.

The movement plan producing system of this aspect communicates with the plurality of vehicles, acquires the residual hydrogen amount information, and produces the movement plan using the residual hydrogen amount information and the positional information. This achieves an increased degree of accuracy of expectation of hydrogen demand for producing the foregoing movement plan, compared to a configuration of producing a movement plan on the basis of a performance value in the past.

[2] In the movement plan producing system of the foregoing aspect, the plan producing portion may include a selection portion that selects a vehicle to become a target of charging with hydrogen gas as a charging target vehicle from the plurality of vehicles using at least the acquired residual hydrogen amount information, and the plan producing portion may produce the movement plan for filling the selected charging target vehicle with hydrogen. As the movement plan producing system of this aspect selects the charging target vehicle from the plurality of vehicles using the residual hydrogen amount information, a vehicle of a high degree of demand for hydrogen charging is selectable as the charging target vehicle.

[3] In the movement plan producing system of the foregoing aspect, the selection portion may select a vehicle having a smaller residual hydrogen amount in the hydrogen tank preferentially as the charging target vehicle over a vehicle having a larger residual hydrogen amount using the acquired residual hydrogen amount information. As the movement plan producing system of this aspect allows a vehicle having a smaller residual hydrogen amount in the hydrogen tank to be selected preferentially as the charging target vehicle, it becomes possible to perform hydrogen charging using the hydrogen filling vehicle before a residual hydrogen amount in the hydrogen tank of each vehicle becomes an excessively reduced state.

[4] In the movement plan producing system of the foregoing aspect, the selection portion may select a vehicle having the hydrogen tank determined not to be in a fully charged state as the charging target vehicle using the residual hydrogen amount information from the plurality of the vehicles. As the movement plan producing system of this aspect allows the vehicle having the hydrogen tank determined not to be in a fully charged state to be selected as the charging target vehicle, it becomes possible to perform hydrogen charging using the hydrogen filling vehicle before a residual hydrogen amount in the hydrogen tank of each vehicle becomes an excessively reduced state.

[5] The movement plan producing system of the foregoing aspect may further include an authentication information acquisition portion that acquires authentication information for unlocking charging ports of the hydrogen tanks provided at the vehicles, and an authentication information transmission portion that transmits the acquired authentication information to a terminal provided to the hydrogen filling vehicle or to a terminal of an operator of the hydrogen filling vehicle. As the movement plan producing system of this aspect acquires the authentication information for unlocking the charging port of the hydrogen tank of the charging target vehicle and transmits the acquired authentication information to the terminal of the hydrogen filling vehicle or to the terminal of the operator of the hydrogen filling vehicle, a user of a vehicle as a charging target is not required to wait in the vehicle for hydrogen charging by the hydrogen filling vehicle, thereby improving convenience.

This disclosure is feasible in various aspects other than the movement plan producing system for the hydrogen filling vehicle. For example, this disclosure is feasible in aspects such as a movement plan producing method for a hydrogen filling vehicle, a computer program for realizing the method, and a non-transitory storage medium storing the computer program, for example.

What is claimed is:

1. A movement plan producing system that produces a movement plan for a hydrogen filling vehicle comprising:
a residual hydrogen amount information acquisition portion that communicates with a plurality of vehicles using hydrogen gas as fuel to acquire residual hydrogen amount information indicating a residual hydrogen amount in a hydrogen tank of each of the vehicles;
a positional information acquisition portion that acquires positional information indicating the position of each of the plurality of vehicles; and
a plan producing portion that produces the movement plan for making the hydrogen filling vehicle fill at least some of the plurality of vehicles with hydrogen using the acquired residual hydrogen amount information and the acquired positional information.

2. The movement plan producing system according to claim 1, wherein
the plan producing portion comprises a selection portion that selects a vehicle to become a target of charging with hydrogen gas as a charging target vehicle from the plurality of vehicles using at least the acquired residual hydrogen amount information, and
the plan producing portion produces the movement plan for filling the selected charging target vehicle with hydrogen.

3. The movement plan producing system according to claim 2, wherein
the selection portion selects a vehicle having a smaller residual hydrogen amount in the hydrogen tank preferentially as the charging target vehicle over a vehicle having a larger residual hydrogen amount using the acquired residual hydrogen amount information.

4. The movement plan producing system according to claim 2, wherein
the selection portion selects a vehicle having the hydrogen tank determined not to be in a fully charged state as the charging target vehicle using the residual hydrogen amount information from the plurality of the vehicles.

5. The movement plan producing system according to claim 1, further comprising:
an authentication information acquisition portion that acquires authentication information for unlocking charging ports of the hydrogen tanks provided at the vehicles; and
an authentication information transmission portion that transmits the acquired authentication information to a terminal provided to the hydrogen filling vehicle or to a terminal of an operator of the hydrogen filling vehicle.

6. A movement plan producing method of producing a movement plan for a hydrogen filling vehicle comprising:
communicating with a plurality of vehicles using hydrogen gas as fuel to acquire residual hydrogen amount information indicating a residual hydrogen amount in a hydrogen tank of each of the vehicles;
acquiring positional information indicating the position of each of the plurality of vehicles; and
producing the movement plan for making the hydrogen filling vehicle fill at least some of the plurality of vehicles with hydrogen using the acquired residual hydrogen amount information and the acquired positional information.
